(19) United States
(12) Patent Application Publication
(10) Pub. No.: US 2026/0100630 A1
(43) Pub. Date: Apr. 9, 2026

(54) SUPERCONDUCTING MAGNET, A SUPERCONDUCTING ROTARY MACHINE HAVING THE SAME, AND A METHOD FOR MANUFACTURING A SUPERCONDUCTING MAGNET

(71) Applicants: HYUNDAI MOTOR COMPANY, Seoul (KR); KIA CORPORATION, Seoul (KR)

(72) Inventors: Hoo Dam Lee, Seoul (KR); Tae Gyu Lee, Seoul (KR); Hyung Kwan Jang, Uijeongbu-si (KR); Jun Hyeok Choi, Suwon-si (KR); Byung Ho Min, Suwon-si (KR); Kyung Sik Choi, Seoul (KR)

(73) Assignees: HYUNDAI MOTOR COMPANY, Seoul (KR); KIA CORPORATION, Seoul (KR)

(21) Appl. No.: 18/920,497

(22) Filed: Oct. 18, 2024

(30) Foreign Application Priority Data
Mar. 26, 2024 (KR) 10-2024-0041336

(51) Int. Cl. H02K 55/00; H02K 15/043

(52) U.S. Cl. CPC H02K 55/00; H02K 15/0432

(57) ABSTRACT

The present disclosure relates to a superconducting magnet that may be more stably and easily manufactured, a superconducting rotary machine having the same, and a method for manufacturing a superconducting magnet. The superconducting magnet may include at least a wound superconducting wire, and the superconducting wire may include a substrate and a superconducting layer stacked on the substrate.

### CROSS-REFERENCE TO RELATED APPLICATION(S)

This application claims priority to and the benefit of Korean Patent Application No. 10-2024-0041336 filed on Mar. 26, 2024, in the Korean Intellectual Property Office, the disclosure of which is incorporated herein by reference in its entirety.

### TECHNICAL FIELD

The present disclosure relates to a superconducting magnet that may be more stably and easily manufactured, a superconducting rotary machine having the same, and a method for manufacturing a superconducting magnet.

### BACKGROUND

In a superconducting rotary machine, such as a superconducting motor or a superconducting generator, a superconductor with an electrical resistance close to zero may be used as a superconducting magnet instead of a conventional copper wire. A superconducting magnet containing a superconductor may be formed by winding a superconducting wire in a racetrack shape.

A high-temperature superconducting wire operating at a liquid nitrogen temperature may have a stacked structure of a metal substrate, a buffer layer, a superconducting layer, and a stabilizing layer. Additionally, an outer surface of the superconducting wire may be provided with a coating layer formed of a conductive metal such as Cu and Ag, or an alloy thereof.

When configuring a superconducting magnet using the superconducting wire, in consideration of a bending radius of the superconducting wire and the elastic modulus of the substrate, winding is performed with a specific load applied to prevent the wire from unraveling. If deviation between turns occurs during winding, it may be difficult to secure a constant magnetic field when applying current. Additionally, when the tension of the winding is not constant, buckling (i.e., a phenomenon in which a superconducting wire is distorted by a magnetic field) occurs due to a magnetic field, and the wire therefore may not be used as a magnet.

### SUMMARY

The present disclosure provides a superconducting magnet that may be more stably and easily manufactured, a superconducting rotary machine having the same, and a method for manufacturing a superconducting magnet.

The present disclosure also provides a superconducting magnet in which a size (thickness) thereof may be adjusted as desired, a superconducting rotary machine having the same, and a method for manufacturing a superconducting magnet.

A superconducting magnet according to the present disclosure may include at least a wound superconducting wire, and the superconducting wire may include a substrate and a superconducting layer stacked on the substrate.

The superconducting layer may be formed by mixing and pasting a superconducting material and a binder, and then filling the pasted superconducting material in a space between one turn and another turn of the substrate and curing the pasted superconducting material.

The superconducting material may include rare earth barium copper oxide.

The superconducting material may include at least one of rare earth metals of yttrium (Y), gadolinium (Gd), neodymium (Nd), samarium (Sm), and dysprosium (Dy).

The substrate may be formed of a non-magnetic metal or alloy.

A surface roughness of the substrate may range from Ra 0.5 to 1 μm.

A gap between one turn and another turn of the substrate may range from 50 μm to 5 mm.

The superconducting wire may be wound in a spiral shape and/or may be wound in an oval shape in which a straight portion thereof may be longer than a curved portion thereof.

The superconducting magnet may further include a bobbin coupled to the superconducting wire.

The superconducting magnet may include a terminal connected to an end of the superconducting wire.

A superconducting rotary machine may include a rotor having a plurality of superconducting magnets arranged in a circumferential direction of a rotor core, and at least one of the plurality of superconducting magnets may be configured as described above.

A method for manufacturing a superconducting magnet according to the present disclosure may include: preparing a winding shaped body in which a substrate may be wound to have a space between one turn and another turn; preparing a paste including a superconducting material; immersing the winding shaped body in the paste; and forming a superconducting layer on the substrate by extracting the winding shaped body from the paste and curing the paste attached to the winding shaped body.

Preparing the winding shaped body may include: forming a sacrificial layer on one side surface of the substrate; forming the winding shaped body by winding the substrate; and removing the sacrificial layer by heat treating the winding shaped body.

The sacrificial layer may be formed of a thermoplastic resin or paraffin.

Preparing the winding shaped body may include 3D printing the winding shaped body.

The paste may be formed by mixing rare earth barium copper oxide with a binder and the paste may be accommodated in an immersion tank. A weight ratio of the binder and the rare earth barium copper oxide may be 1:10.

When immersing the winding shaped body, vibration may be applied to the immersion tank.

The paste may have a viscosity ranging from 50,000 to 1,000,000 cP at a temperature of 25° C., a humidity of 65%, and an atmospheric pressure.

Before immersing the winding shaped body, a bobbin shaped body may be inserted into the winding shaped body. When the paste is cured, the bobbin shaped body may be separated from the winding shaped body.

After the superconducting layer is formed, a side surface of the substrate may be polished to separate superconducting layers connected to each other across the substrate in the winding shaped body.

According to an embodiment of the present disclosure, a superconducting wire having a simple structure may be manufactured through a simplified process, so that a superconducting magnet may be manufactured quickly and easily.

In addition, according to an embodiment of the present disclosure, a thickness of a substrate of a superconducting wire and a superconducting layer may be adjusted as desired, so that a current of tens of thousands of A or more may be applied to the superconducting wire.

### BRIEF DESCRIPTION OF DRAWINGS

The above and other aspects, features, and advantages of the present disclosure should be more clearly understood from the following detailed description, taken in conjunction with the accompanying drawings, in which:

FIG. 1 is a perspective view illustrating a rotor to which a superconducting magnet according to one embodiment of the present disclosure is applied;

FIG. 2 is an enlarged perspective view illustrating one of the superconducting magnets of FIG. 1;

FIG. 3 is a perspective view showing a portion of a superconducting wire included in a superconducting magnet according to one embodiment of the present disclosure;

FIG. 4 is a view illustrating a method for manufacturing a superconducting magnet according to a first embodiment of the present disclosure;

FIG. 5 is a view illustrating a method for manufacturing a superconducting magnet according to a second embodiment of the present disclosure; and

FIGS. 6, 7A and 7B are perspective views illustrating a mobility device or vehicle in which a superconducting rotary machine according to one embodiment of the present disclosure is applied as a superconducting motor.

### DETAILED DESCRIPTION

Hereinafter, the present disclosure is described in detail with reference to the accompanying drawings. In adding reference numerals to elements of each of the drawings, although the same elements are illustrated in other drawings, like reference numerals may refer to like elements.

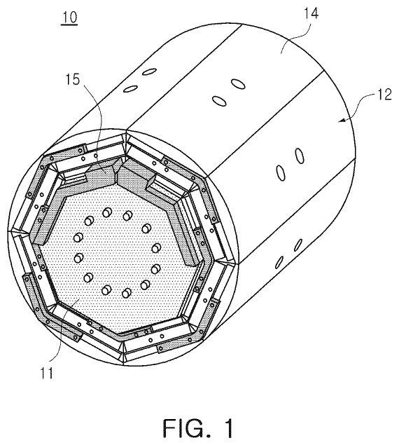

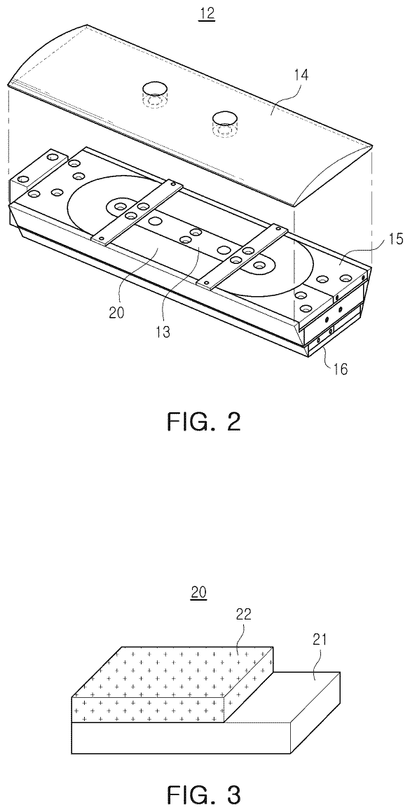

FIG. 1 is a perspective view illustrating a rotor 10 to which a superconducting magnet 12 according to the present disclosure is applied. FIG. 2 is an enlarged perspective view illustrating one of the superconducting magnets 12 of FIG. 1.

In one embodiment, a superconducting rotary machine, such as a superconducting motor or a superconducting generator, may include a rotor 10 and a stator (not illustrated). A superconducting rotary machine may be formed by surrounding a stator with an armature and the outside of the rotor 10 with a superconducting magnet 12. The superconducting rotary machine may generate rotational force (motor) or electric power (generator) together with the stator when the rotor 10 rotates.

An example in which the superconducting magnet 12 according to the present disclosure may be applied to the rotor 10 is mainly illustrated and explained, but the present disclosure is not necessarily limited thereto. When an armature coil of the stator uses a superconducting wire 20, the superconducting magnet 12 may also be applied to the stator.

The rotor 10 of the superconducting rotary machine may include a rotor core 11 and a plurality of superconducting magnets 12 arranged in a circumferential direction of the rotor core 11.

The rotor core 11 may be coupled to an axially extending shaft (not illustrated) in or near a radial center thereof. For this purpose, a hole for coupling the shaft may be formed in the radial center of the rotor core 11, but a coupling method between the rotor core 11 and the shaft is not necessarily limited to the above-described examples. For example, shafts may be fixedly coupled to the centers of both end surfaces of the rotor core 11 without holes.

A plurality of coupling portions (not illustrated) may be formed on an outer peripheral surface of the rotor core 11 at predetermined intervals in the circumferential direction to mount and support the superconducting magnet 12. The coupling portion may be molded integrally with the rotor core 11 or may be manufactured separately and assembled to the rotor core 11.

In one embodiment, each of the coupling portions may be formed to protrude radially from the rotor core 11 and be fitted and coupled to the superconducting magnet 12 or a bobbin 13 around which the superconducting magnet 12 is wound. However, the shape of the coupling portion is not necessarily limited thereto, and the coupling portion may be formed in the form of a flat surface supporting the superconducting magnet 12 or a groove accommodating a portion of the bobbin 13.

The superconducting magnet 12 may include at least a wound superconducting wire 20. Additionally, the superconducting magnet 12 may further include a bobbin 13 to which the superconducting wire 20 may be coupled. The detailed constitution of the superconducting wire 20 is described below.

The bobbin 13 may serve as a support for winding the superconducting wire 20 and may form a magnetic flux path carrying magnetic flux. The bobbin 13 may have a shape such as a cylindrical shape, a square cylinder shape, or an oval shape. In FIG. 2, a bobbin 13 having an oval shape (i.e., a racetrack shape), in which a straight portion thereof may be formed to be longer than a curved portion thereof, is illustrated.

In one embodiment, the superconducting wire 20 may be coupled around the bobbin 13, and terminals 15 may be connected to both ends of the superconducting wire 20, for example, an inner end and an outer end. The superconducting wire 20 may be physically and/or electrically connected to a power source (not illustrated) via the terminal 15. Accordingly, a large amount of current may be applied to the superconducting magnet 12.

When the superconducting magnet 12 is coupled to a coupling portion of the rotor core 11, the superconducting magnet 12 and the coupling portion may form one pole. As an example, the rotor 10 illustrated in FIG. 1 has eight poles.

When the large amount of current is applied from a power source to the superconducting wire 20, a magnetic field may be formed in the superconducting magnet 12.

The superconducting magnet 12 may include an outer cover 14 configured to cover a radial outer side to protect components thereof. The outer cover 14 may be coupled to the bobbin 13, e.g., by bolting. Additionally, the superconducting magnet 12 may further include an inner cover 16 configured to cover a radial inner side and coupled to the bobbin 13.

In this manner, the rotor 10 provided with the superconducting magnet 12 may be cooled to extremely low temperature by a cooling system (not illustrated) because the rotor 10 uses a superconductivity phenomenon and may be accommodated into a vacuum chamber for insulation from the outside. In this example, the vacuum chamber may be interposed between the rotor 10 and the stator and may surround the rotor 10.

To lower a temperature of the superconducting wire 20 to a critical temperature, the superconducting magnet 12 may be connected to a cooling system. A refrigerator of the cooling system may be provided separately outside the rotary machine, or may be mounted in the rotor 10 and/or the vacuum chamber. In this case, the refrigerator may supply and recover liquid or gaseous refrigerant to the rotor 10 and circulate the refrigerant. Since various cooling systems have been proposed to cool the superconducting rotary machine to cryogenic temperatures, detailed description thereof have been omitted in this specification.

The rotor 10 of the superconducting rotary machine configured as described above may be installed to be rotatable by having a shaft coupled to the rotor core 11 and supporting the shaft and the rotor 10 by bearing.

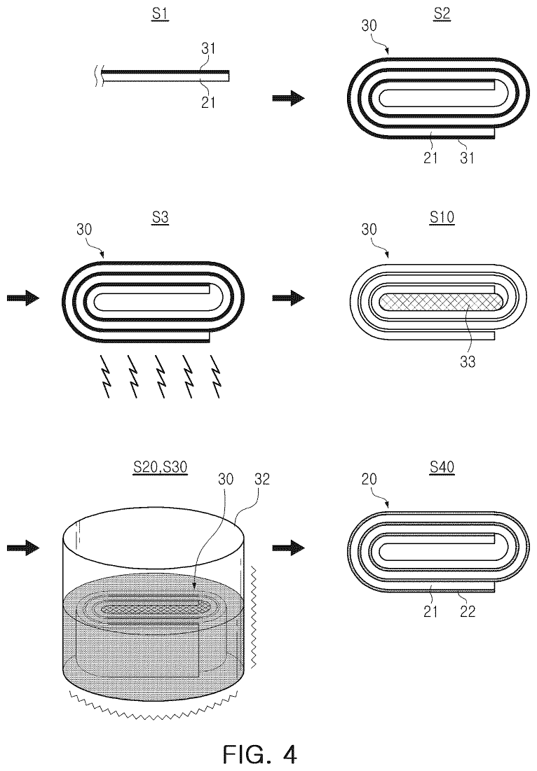

FIG. 3 is a perspective view showing a portion of a superconducting wire 20 included in a superconducting magnet 12 according to one embodiment of the present disclosure.

The superconducting wire 20 may include a substrate 21 formed of a metal or an alloy, and a superconducting layer 22 stacked on the substrate 21.

The substrate 21 may be formed of a thin film-shaped wire and may support the superconducting layer 22. A roughness of at least one surface of the substrate 21 may be adjusted to correspond to a level at which deposition is possible, e.g., through electrolytic polishing.

The substrate 21 does not have magnetic properties and may maintain a stable state at high temperatures. For example, the substrate 21 may be formed of at least one material selected from the group consisting of hastelloy, austenitic stainless steel, and an Al—Mg alloy. Accordingly, the substrate 21 allows the superconducting wire 20 on which the superconducting layer 22 is stacked to maintain a winding shape.

The superconducting layer 22 may be attached and stacked on at least one side surface of the substrate 21. Such a superconducting layer 22 may be formed by mixing and pasting rare-earth barium copper oxide (hereinafter referred to as “REBCO”) and a binder, and then filling the pasted superconducting material in a space between one turn and another turn of a wound substrate 21 and curing the pasted superconducting material.

The REBCO may include at least one of rare earth metals such as yttrium (Y), gadolinium (Gd), neodymium (Nd), samarium (Sm), and dysprosium (Dy).

Examples of specific types of binders for pasting the REBCO are not limited, and various widely known polymer resins, organic solvents, inorganic solvents, aqueous solvents, and the like, may be used as binders.

More specifically, the binder may include, for example, one or more selected from the group consisting of polystyrene, o-xylene, dichloromethane, acrylic resin, butyl acetate, α-terpineol, carboxymethyl cellulose sodium salt, and epoxidized soybean oil.

When the REBCO is mixed with the binder in this manner, a paste for forming a superconductor may be produced. For example, the binder may be included in an amount of about 1 to 10 wt %, and a weight ratio of the binder and the REBCO may be approximately 1:10.

The prepared paste may have a viscosity ranging from about 50,000 to 1,000,000 cP at a temperature of 25° C., a humidity of 65%, and an atmospheric pressure. In one embodiment, the prepared paste may have a viscosity of about 100,000 to 500,000 cP.

A surface roughness of the substrate 21 to which the paste is attached may range from Ra 0.5 to 1 μm. When the surface roughness of the substrate 21 is less than Ra 0.5 μm, the paste may not be firmly attached to the substrate 21. Conversely, when the surface roughness of the substrate 21 exceeds Ra 1 μm, a thickness of the paste attached to the substrate 21 becomes uneven, which may make it difficult to secure a uniform magnetic flux.

Additionally, a gap between one turn and another turn of the wound substrate 21 immersed in the paste may range from 50 μm to 5 mm. Adhesion between the paste and the substrate 21 depends on a particle size of the composition and the viscosity of the paste, and the like. When the gap between the turns of the wound substrate 21 is formed to be smaller than 50 μm, it may be difficult for the paste to flow in, which may increase the probability that pores may exist between the turns. Thus, a firm attachment may not be ensured. On the other hand, when the gap between the turns of the wound substrate 21 exceeds 5 mm (e.g., as the thickness of the paste increases), the superconducting layer 22 may become brittle, which may lead to the risk in that the superconducting layer 22 may be easily broken by external shock.

The superconducting wire 20 of the superconducting magnet 12 according to one embodiment of the present disclosure may be comprised of at least a portion of the superconducting layer 22 by utilizing the paste formed of a superconducting material. In this example, because the superconducting layer 22 may have reduced mechanical strength basically based on a ceramic material, the substrate 21 may be provided to maintain the shape of the superconducting layer 22 and supplement strength thereof, so that the superconducting wire 20 may stably exhibit superconducting properties.

The superconducting layer 22 formed by curing the paste may have a significantly lower critical current than a thin film type superconducting wire. However, due to the characteristics of the paste, since the superconducting layer 22 is not limited to the shape manufactured (e.g., a thin film), the superconducting layer 22 and the superconducting wire 20 provided therewith may have the advantage of being able to be formed into various shapes and manufactured to a desired size (e.g., especially thickness).

Moreover, since an actual thickness of the thin film type superconducting wire may be 1 to 3 μm, a current that may be applied may be limited to 1000 A or less. However, in one embodiment, a thickness of the superconducting layer 22 may be adjusted in the range of 50 μm to 5 mm so that a current of tens of thousands of A or more may be applied.

Additionally, in one embodiment, the thickness of the superconducting layer 22 may be formed relatively thick at a specific portion of the superconducting wire 20, thereby providing the additional advantage of alleviating the hoop stress occurring when the superconducting wire 20 is wound in a racetrack shape.

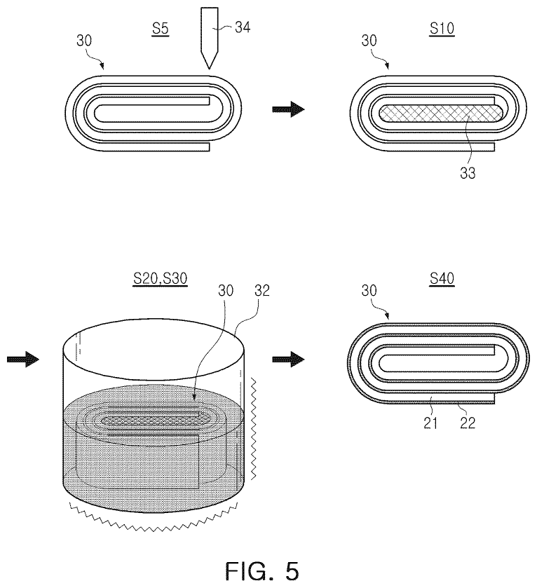

FIG. 4 is a view illustrating a method for manufacturing a superconducting magnet 12 according to a first embodiment of the present disclosure.

A method for manufacturing a superconducting magnet 12 according to a first example embodiment of the present disclosure may include: an operation of preparing a winding shaped body 30 in which a substrate 21 may be wound to have a space between one turn and another turn (S10); an operation of preparing a paste including a superconducting material (S20); an operation of immersing the winding shaped body 30 in the paste (S30); and an operation of forming the superconducting layer 22 on the substrate 21 of the winding shaped body 30 by extracting the winding shaped body 30 from the paste and curing the paste attached to the winding shaped body 30 (S40).

As described above, the substrate 21 may be formed of a thin film type wire 20 using at least one material that does not have magnetic properties (e.g., hastelloy, austenitic stainless steel, and an Al—Mg alloy) and may be wound in approximately a spiral shape to form the winding shaped body 30 (S10). The winding shaped body 30 may have an oval shape (i.e., a racetrack shape), in which a straight portion thereof may be formed to be longer than a curved portion thereof.

In the method for manufacturing a superconducting magnet 12 according to the first example embodiment of the present disclosure, the operation of preparing the winding shaped body 30 (S10) may include: an operation of forming a sacrificial layer 31 on one side surface of the substrate 21 (S1); an operation of forming a winding shaped body 30 by winding the substrate 21 (S2); and an operation of removing the sacrificial layer 31 by heat treating the winding shaped body 30 (S3).

A sacrificial layer 31 formed of, for example, a thermoplastic resin or paraffin, may be stacked on one side surface of the substrate 21 formed of the thin film type wire 20.

In one embodiment, the thermoplastic resin may include one or more selected from the group consisting of a polyethylene resin, a polypropylene resin, a vinyl chloride resin, a vinyl acetate resin, a polystyrene resin, an Acrylonitrile Butadiene Styrene (ABS) resin, an acrylic resin, and a polyamide resin.

The sacrificial layer 31 may be formed by coating a material such as a thermoplastic resin or paraffin on one side surface of the substrate 21 by screen printing, digital printing, roller coating, or spray coating, and then drying the material (S1). A thickness of the sacrificial layer 31 may range from 50 μm to 5 mm.

The substrate 21 on which the sacrificial layer 31 is stacked may be wound in a substantially spiral shape to form the winding shaped body 30 having a racetrack shape (S2). A substrate 21 on which the sacrificial layer 31 is stacked may be wound with a very high degree of freedom of shape because, unlike before, there is no limit to the bending radius.

In one embodiment, to counter hoop stress generated by the magnetic field, points where hoop stress may occur may be predicted in the substrate 21. During winding, the same material as the sacrificial layer 31 may be utilized, thereby adjusting the thickness of the sacrificial layer 31 at predicted points.

When the formation of the winding shaped body 30 is completed, the winding shaped body 30 may be heat treated at a temperature of at least 550° C. so that the sacrificial layer 31 formed of the thermoplastic resin or paraffin may be removed from the substrate 21 of the winding shape body 30 (S3). The heat treatment may be performed in any heating device such as an oven or a furnace.

Accordingly, in the winding shaped body 30, a space into which the paste of the superconducting material may be inserted may be uniformly secured between the turns of the substrate 21.

Even after heat treatment, the winding shaped body 30 may maintain a wound shape thereof. The remaining sacrificial layer 31 that has not been removed through the heat treatment may be removed by applying ultrasonic waves to the winding shaped body 30 using, for example, an ultrasonic cleaner.

Next, the paste may be formed and prepared by mixing the superconducting material with the binder (S20). For example, after mixing and pasting the REBCO and the binder, the pasted superconducting material may be accommodated in an immersion tank 32 of a predetermined size. The binder may be included in an amount of about 1 to 10 wt %, and a weight ratio of the binder and the REBCO may be approximately 1:10.

Additionally, the paste may have a viscosity ranging from about 50,000 to 1,000,000 cP at a temperature of 25° C., a humidity of 65%, and an atmospheric pressure. In one embodiment, the paste may have a viscosity of about 100,000 to 500,000 cP.

The winding shaped body 30 may be immersed in the immersion tank 32 accommodating the paste of the superconducting material (S30). The winding shaped body 30 may be immersed in the immersion tank 32 of the paste for several seconds to several minutes so that the paste may sufficiently fill the space between the turns of the wound substrate 21.

To minimize the possibility of pores forming between the turns of the substrate 21, vibration may be applied to the immersion tank 32. The application of the vibration may be performed by any vibration generator capable of supporting or accommodating the immersion tank 32.

Additionally, in one embodiment, to form a space to be coupled with the bobbin 13, before immersing the winding shaped body 30 in the immersion tank 32, a bobbin shaped body 33 may be inserted into a center of the winding shaped body 30. The bobbin shaped body 33 may be formed of a material that is sturdy and easy to form or process, such as plastic, ceramic, wood, or a metal. The bobbin shaped body 33 may have a shape corresponding to the bobbin 13.

Next, the winding shaped body 30 in which the paste penetrates a space between the turns of the substrate 21 may be extracted from the immersion tank 32, and the paste may be cured. Accordingly, the superconducting layer 22 may be formed on the substrate 21 of the winding shaped body 30 (S40). When the paste is cured, the bobbin shaped body 33 may be separated from the winding shaped body 30.

In the method for manufacturing a superconducting magnet 12 according to the first example embodiment of the present disclosure, after the superconducting layer 22 is formed, the side surface of the substrate 21 may be polished to separate the superconducting layers 22 connected to each other across the substrate 21 in the winding shape body 30.

When the winding shaped body 30 into which the paste has penetrated is taken out from the immersion tank 32, the paste may also adhere to both sides of the substrate 21 other than in a stacking direction of the substrate 21. As the paste is cured in this state, one turn of the superconducting layer 22 and another adjacent turn may be physically and electrically connected to each other across the substrate 21.

By polishing both side surfaces of the substrate 21 to separate the superconducting layers 22 connected to each other, the turns of the superconducting layer 22 may be insulated from each other.

Accordingly, the superconducting layer 22 may be attached to and stacked on at least one side surface of the substrate 21 so that the superconducting magnet 12, including the superconducting wire 20 in a wound form, may be completed.

In one embodiment, when the superconducting magnet 12 is provided with the bobbin 13, the superconducting wire 20 in the wound form may be fitted and coupled around the bobbin 13.

As described above, according to the first example embodiment of the present disclosure, the superconducting wire 20 having the simple structure may be manufactured through a simplified process so that the superconducting magnet 12 may be manufactured quickly and easily.

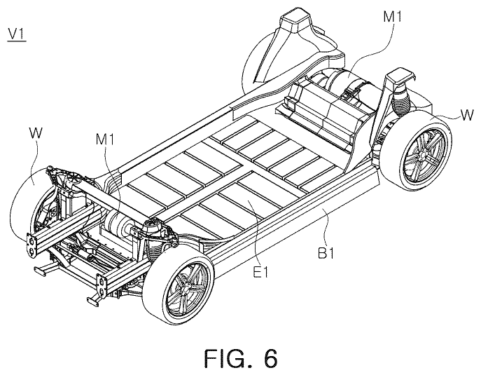

FIG. 5 is a view illustrating a method for manufacturing a superconducting magnet 12 according to a second example embodiment of the present disclosure.

A method for manufacturing a superconducting magnet 12 according to a second example embodiment of the present disclosure may include: an operation of preparing a winding shaped body 30 in which the substrate 21 may be wound to have a space between one turn and another turn (S10); an operation of preparing a paste including a superconducting material (S20); an operation of immersing the winding shaped body 30 in the paste (S30); and an operation of forming the superconducting layer 22 on the substrate 21 of the winding shaped body 30 by extracting the winding shaped body 30 from the paste and curing the paste attached to the winding shaped body 30 (S40).

The second example embodiment illustrated in FIG. 5 is different from the first example embodiment only in the method of the operation of preparing the winding shaped body 30, and the remaining constitutions of the second example embodiment are the same as those of the first example embodiment. Accordingly, in describing the method for manufacturing a superconducting magnet 12 according to the second example embodiment, the same reference numerals may be assigned to the constitutions that are the same as those in the method for manufacturing the superconducting magnet 12 according to the first example embodiment described above, and detailed descriptions of configuration and functions thereof have been omitted.

As described above, the substrate 21 may be formed of a thin film type wire 20 using at least one material that does not have magnetic properties, such as hastelloy, austenitic stainless steel, and an Al—Mg alloy, and may be wound approximately in a spiral shape to form the winding shaped body 30 (S10). The winding shaped body 30 may have an oval shape (i.e., a racetrack shape), in which a straight portion thereof may be formed to be longer than a curved portion thereof.

In the method for manufacturing a superconducting magnet 12 according to the second example embodiment of the present disclosure, the operation of preparing the winding shaped body 30 (S10) may include an operation of 3D printing the winding shaped body 30 using a 3D printer 34 for a metal (S5).

To print in 3D, a model for the winding shaped body 30 may be modeled in 3D using data of the winding shaped body 30 obtained and stored through execution of a 3D CAD program. Then, the 3D modeled model of the winding shaped body 30 may be used to generate design data for the winding shaped body 30. In this example, the design data is design information modeled in 3D CAD and may include numerical data or image data modeled to have a space between the turns of the substrate 21 corresponding to an actual winding shaped body 30 (i.e., a space that may be filled with a paste).

The design data must include data related to the shape and dimensions of a space to exist between the turns of the substrate 21 as well as the winding shaped body 30.

The 3D printer 34 may allow the winding shaped body 30 to be formed, by receiving design data, and 3D printing the winding shaped body 30 according to the design data using metallic materials such as hastelloy, austenitic stainless steel, and an Al—Mg alloy.

As the 3D printer 34, a known 3D printer for metal may be used. A basic principle of the known 3D printer is that a desired product made on a computer using a 3D CAD program may be designed and saved in a data form. Then, the designed 3D model may be divided into thin layers, layer by layer, and the thin layers may be piled up one after another from the bottom to undergo an integration process, thereby obtaining one three-dimensional print. In this case, a thickness of the layer may be about 0.1 mm or less, which is thinner than a sheet of paper. This may make it possible to generate elaborate three-dimensional shapes.

Next, the paste may be formed and prepared by mixing a superconducting material with the binder (S20). For example, after mixing and pasting the REBCO and the binder, the pasted superconducting material may be accommodated in an immersion tank 32 of a predetermined size.

The winding shaped body 30 may be immersed in the immersion tank 32 accommodating the paste of the superconducting material (S30). The winding shaped body 30 may be immersed in the immersion tank 32 of the paste for several seconds to several minutes so that the paste may sufficiently fill the space between the turn and the turn of the substrate 21.

To minimize the possibility of pores forming between the turns of the substrate 21, vibration may be applied to the immersion tank 32. The application of vibration may be performed by any vibration generator capable of supporting or accommodating the immersion tank 32.

Additionally, in one embodiment, to form a space to be coupled with the bobbin 13, before immersing the winding shaped body 30 in the immersion tank 32, a bobbin shaped body 33 may be inserted in a center of the winding shaped body 30.

Next, the winding shaped body 30 in which the paste penetrates a space between the turns of the substrate 21 may be extracted from the immersion tank 32, and the paste may be cured. Accordingly, the superconducting layer 22 may be formed on the substrate 21 of the winding shaped body 30 (S40). When the paste is cured, the bobbin shaped body 33 may be separated from the winding shaped body 30.

In the method for manufacturing a superconducting magnet 12 according to the second example embodiment of the present disclosure, after the superconducting layer 22 is formed, the side surface of the substrate 21 may be polished to separate the superconducting layers 22 connected to each other across the substrate 21 in the winding shaped body 30.

By polishing both side surfaces of the substrate 21 to separate the superconducting layers 22 connected to each other, the turns of the superconducting layer 22 may be insulated from each other.

Accordingly, the superconducting layer 22 may be attached to and stacked on at least one side surface of the substrate 21 so that the superconducting magnet 12, including the superconducting wire 20 in a wound form, may be completed.

In one embodiment, when the superconducting magnet 12 is provided with the bobbin 13, the superconducting wire 20 in a wound form may be fitted and coupled around the bobbin 13.

As described above, according to the second example embodiment of the present disclosure, a superconducting wire 20 having the simple structure may be manufactured through a simplified process so that the superconducting magnet 12 may to be manufactured quickly and easily.

A superconducting rotary machine having a superconducting magnet 12 according to the present disclosure may be used as a superconducting motor M1, M2. Hereinafter, application examples are briefly described.

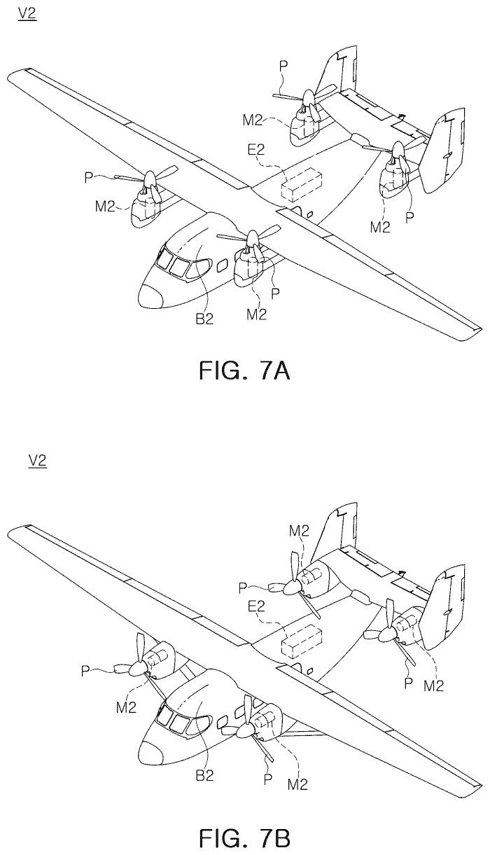

FIGS. 6, 7A and 7B are perspective views illustrating a mobility device or vehicle V1, V2 in which a superconducting rotary machine according to the present disclosure is applied as a superconducting motor M1, M2.

Mobility devices V1 and V2 may at least include bodies B1 and B2, driving means W and P provided in the bodies B1 and B2, superconducting motors M1 and M2 linked to the driving means W and P, and batteries E1 and E2 configured to provide power to the superconducting motor. The superconducting motors M1 and M2 installed in the mobility devices V1 and V2 may have the configuration of the superconducting rotary machine described above.

Referring to FIG. 6, the mobility device V1 may be a vehicle that may be movable on the ground. The vehicle may at least include a body B1, a wheel W that is a driving means W provided in the body B1, a superconducting motor M1 linked to the driving means W, and a battery E1 configured to provide power to the superconducting motor M1.

Additionally, referring to FIGS. 7A and 7B, the mobility device V2 may be an air mobility device V2 moving in the air. The air mobility device V2 may at least include a body B2, a propellant P (e.g., a propeller) as the driving means P provided in the body B2, a superconducting motor M2 linked to the propellant P, and a battery E2 configured to provide power to the superconducting motor M2.

FIG. 7A illustrates a position of the propellant P when the air mobility device V2 takes off, lands, or hovers for turning at a specific point. FIG. 7B illustrates a position of the propellant P when the air mobility device V2 moves (i.e., when the air mobility device V2 operates). In other words, the propeller P, which is the driving means P of the air mobility device V2, may have a structure in which a direction in which the propeller P faces may be tilted, and the superconducting motor M2 that drives the propellant P may also be tilted accordingly.

For a hovering mode illustrated in FIG. 7A, the propellants P of main and/or tail wings may be turned to be substantially perpendicular to the body B2, and for an operating mode illustrated in FIG. 7B, the propellants P of the main and/or tail wings may be turned to be substantially parallel to a longitudinal axis of body B2. Tilting of the propellants P of the main and/or tail wings may be synchronized depending on a flight mode, or tilting of each propellant P may be adjusted differently depending on attitude control and flight conditions in the same flight mode.

Specific illustration is omitted, but the mobility device V1, V2 may be a device that moves in a space, such as on land, underground, in the air, in space, at sea, and/or underwater, depending on the space in which the mobility device moves. Above-ground or underground mobility devices may be provided in the form of, for example, a vehicle, a robot or the like. Mobility devices in the air and space are aerial mobility devices and may be provided, for example, in the form of a conventional fixed-wing or rotary-wing aircraft, a tilt-rotor aircraft, a vertical takeoff and landing aircraft, an unmanned aerial vehicle, a moving means mounted on a drone, a rocket, or an artificial satellite. The maritime or underwater mobility devices may be, for example, a ship, a submarine, or the like. The mobility device is not limited to a specific space and may be a mobile body that may be movable through all of the above-mentioned spaces (i.e., a mobile body that may be moved in multiple spaces), and may be, for example, an amphibious vehicle, a flying vehicle, or the like.

The aforementioned description merely illustrates the technical concept of the present disclosure, and a person having ordinary skill in the art to which the present disclosure pertains may make various modifications and modifications without departing from the essential characteristics of the present disclosure.

Therefore, the embodiments disclosed in this specification and drawings are not intended to limit but to explain the technical concept of the present disclosure, and the scope of the technical idea of the present disclosure is not limited by these embodiments. The scope of protection of the present disclosure should be interpreted by the following claims, and all technical ideas within the scope equivalent thereto should be interpreted as being included in the scope of the present disclosure.

What is claimed is:

1. A device comprising at least a wound superconducting wire,
wherein the superconducting wire includes:
a substrate, and
a superconducting layer stacked on the substrate.

2. The device according to claim 1, wherein the superconducting layer is formed by mixing and pasting a superconducting material and a binder, and
filling the pasted superconducting material in a space between one turn and another turn of the substrate and curing the pasted superconducting material.

3. The device according to claim 2, wherein the superconducting material includes rare earth barium copper oxide.

4. The device according to claim 2, wherein the superconducting material includes at least one of rare earth metals of yttrium (Y), gadolinium (Gd), neodymium (Nd), samarium (Sm), and dysprosium (Dy).

5. The device according to claim 1, wherein the substrate is formed of a non-magnetic metal or alloy.

6. The device according to claim 1, wherein a surface roughness of the substrate ranges from Ra 0.5 to 1 μm.

7. The device according to claim 1, wherein a gap between one turn and another turn of the substrate ranges from 50 μm to 5 mm.

8. The device according to claim 1, wherein the superconducting wire is wound in a spiral shape or an oval shape in which a straight portion thereof is longer than a curved portion thereof.

9. The device according to claim 1, further comprising:
a bobbin coupled to the superconducting wire.

10. The device according to claim 1, further comprising:
a terminal connected to an end of the superconducting wire.

11. A superconducting rotary machine comprising a rotor having a plurality of superconducting magnets arranged in a circumferential direction of a rotor core,
wherein one of the plurality of superconducting magnets is a device configured according to claim 1.

12. A method for manufacturing a superconducting magnet, the method comprising:
preparing a winding shaped body in which a substrate is wound to have a space between one turn and another turn;
preparing a paste including a superconducting material;
immersing the winding shaped body in the paste; and
forming a superconducting layer on the substrate by extracting the winding shaped body from the paste and curing the paste attached to the winding shaped body.

13. The method of claim 12, wherein preparing the winding shaped body includes:
forming a sacrificial layer on one side surface of the substrate;
forming the winding shaped body by winding the substrate; and
removing the sacrificial layer by heat treating the winding shaped body.

14. The method of claim 13, wherein the sacrificial layer is formed of a thermoplastic resin or paraffin.

15. The method of claim 12, wherein preparing the winding shaped body includes 3D printing the winding shaped body.

16. The method of claim 12, wherein the paste is formed by mixing rare earth barium copper oxide with a binder and is accommodated in an immersion tank, and
wherein a weight ratio of the binder and the rare earth barium copper oxide is 1:10.

17. The method of claim 16, wherein in the immersing the winding shaped body, vibration is applied to the immersion tank.

18. The method of claim 12, wherein the paste has a viscosity ranging from 50,000 to 1,000,000 cP at a temperature of 25°C, a humidity of 65%, and an atmospheric pressure.

19. The method of claim 12, wherein before immersing the winding shaped body, a bobbin shaped body is inserted into the winding shaped body, and
wherein when the paste is cured, the bobbin shaped body is separated from the winding shaped body.

20. The method of claim 12, wherein after the superconducting layer is formed, a side surface of the substrate is polished to separate superconducting layers connected to each other across the substrate in the winding shaped body.
